(19) United States
(12) Patent Application Publication
(10) Pub. No.: US 2017/0144875 A1
(43) Pub. Date: May 25, 2017

(54) TOOL INTENDED FOR RAISING A VEHICLE

(71) Applicant: SOFTBANK ROBOTICS EUROPE, PARIS (FR)

(72) Inventor: Vincent CLERC, CLAMART (FR)

(21) Appl. No.: 15/309,726

(22) PCT Filed: Jun. 1, 2015
(86) PCT No.: PCT/EP2015/062065

§ 371 Date: Nov. 8, 2016

(30) Foreign Application Priority Data
May 30, 2014 (FR) 1454921

(51) Int. Cl. B66F 15/00; B66F 3/00

(52) U.S. Cl. CPC B66F 15/00; B66F 3/005

(57) ABSTRACT

A tool for raising a vehicle relative to a reference plane on which the vehicle is intended to move is provided. The tool is formed by a single-piece part having a branch extending along a main axis, to be placed between the vehicle and the reference plane and to be operated by an operator substantially in a rotational movement about the main axis of the branch. In a section of the branch at right angles to the main axis and extending along the main axis, two overall distances D1 and D2 are defined that are angularly offset from one another. The first distance D1 is less than the second distance D2, the distance D1 intended to be less than a distance D separating the vehicle from the reference plane and the distance D2 intended to be greater than the distance D.

The invention relates to a tool intended for raising a vehicle relative to a reference plane on which the vehicle is intended to move.

Many tools called jacks exist, notably in the motor vehicle field. A jack, supplied with the vehicle, notably makes it possible to change a wheel, for example in the event of a blowout. A very widely used jack model conventionally comprises several arms that are rotationally mobile relative to one another. The arms are arranged in rhomboid form and a screw system arranged horizontally makes it possible to modify the length of one of the diagonals of the rhomboid. The length of the other diagonal changes in the reverse direction and makes it possible to raise the vehicle relative to the ground. This type of jack takes a relatively long time to operate.

Larger tools have been developed for workshop use. There are for example tools comprising a hydraulic or pneumatic actuator and that make it possible to raise the vehicle directly or via an angle transmission system. This type of tool is much more bulky and much more costly than an onboard jack.

Generally, the known tools have numerous moving parts which increase the weight of the tool, make it complex and costly and which can also be the source of failure.

The invention aims to mitigate all or some of the problems cited above by proposing a much simpler tool intended for raising a vehicle. In operation, the tool according to the invention is of a single piece, that is to say with no moving parts.

To this end, the subject of the invention is a tool intended for raising a vehicle relative to a reference plane on which the vehicle is intended to move, characterized in that it is formed by a single-piece part having a branch extending essentially along a main axis, intended to be placed between the vehicle and the reference plane and to be operated by an operator substantially in a rotational movement about the main axis of the branch, and in that, in a section of the branch at right angles to the main axis and extending along the main axis, two overall distances D1 and D2 are defined that are angularly offset from one another and in that the first distance D1 is less than the second distance D2, the distance D1 being intended to be less than a distance D separating the vehicle from the reference plane and the distance D2 being intended to be greater than the distance D.

In an advantageous embodiment, the tool comprises a handle that can be dismantled from the branch and that makes it possible, in a mounted position, to rotate the branch about its main axis. The handle and the branch comprise magnetic elements cooperating with one another to maintain the handle and the branch in a dismantled position.

The invention will be better understood and other advantages will become apparent on reading the detailed description of an embodiment given by way of example, the description being illustrated by the attached drawing in which:

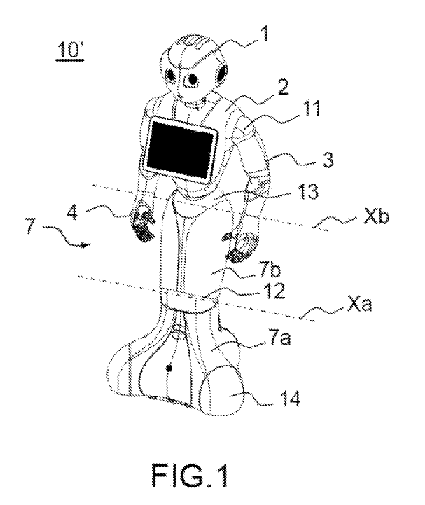

FIG. 1 represents an exemplary robot that can be raised by a tool according to the invention;

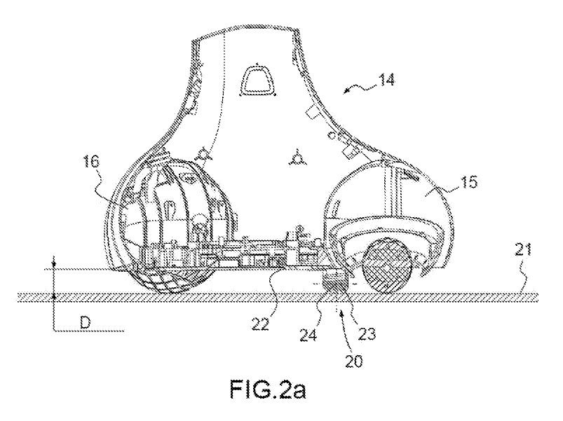

FIGS. 2a and 2b represent an example of a tool according to the invention and arranged relative to the base of the robot of FIG. 1;

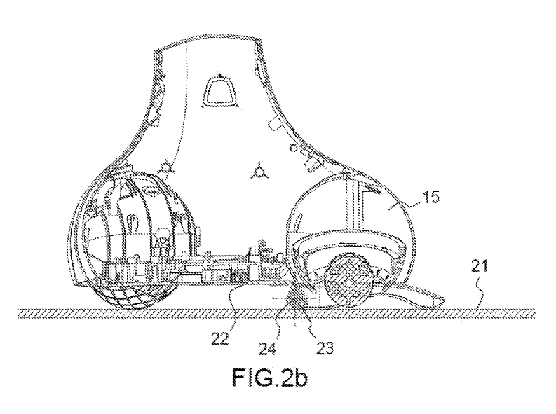

FIG. 3 represents, in cross section, the tool of FIGS. 2a and 2b;

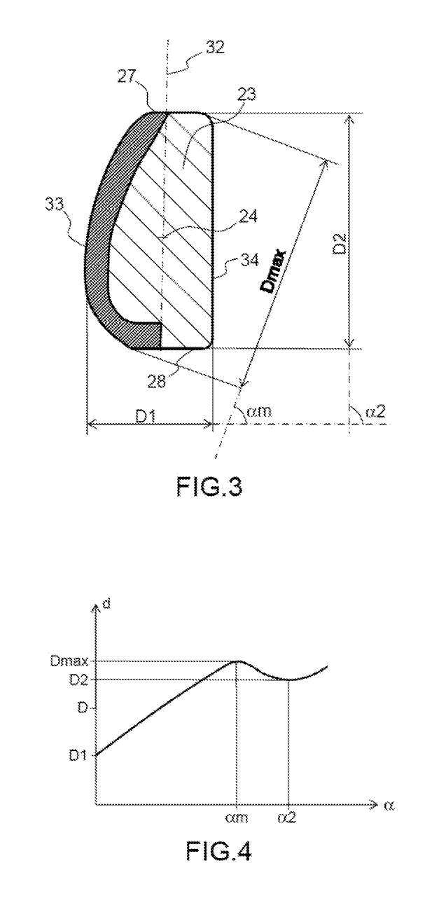

FIG. 4 represents a curve showing the appearance of the trend of a current distance d of a section of the tool as a function of a tool rotation angle;

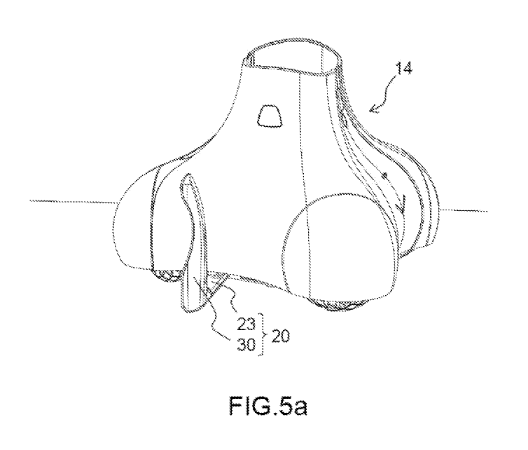

FIGS. 5a and 5b represent the tool equipped with a handle;

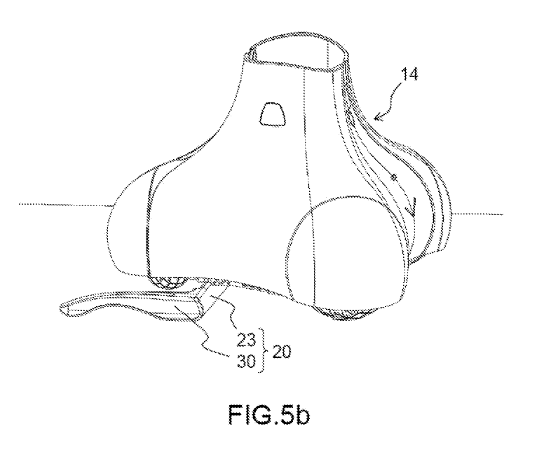

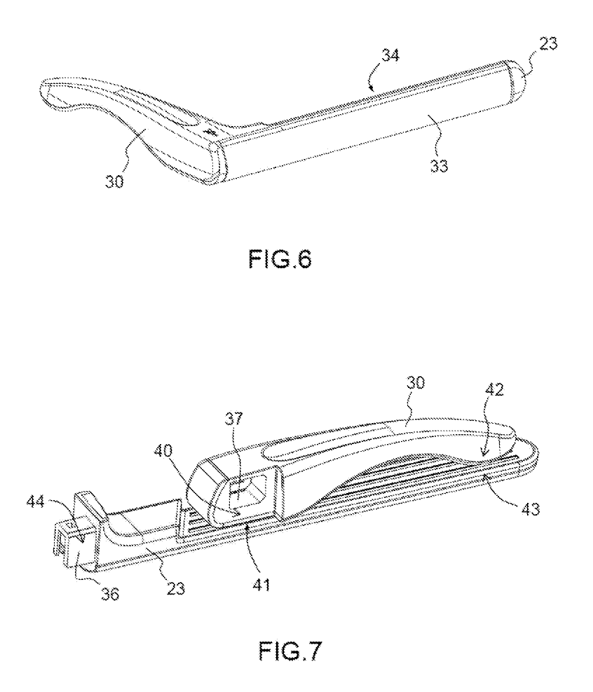

FIGS. 6 and 7 represent the tool alone, FIG. 6 in functional position and FIG. 7 in folded-down position.

For clarity, the same elements will bear the same references in the different figures.

The tool according to the invention can be implemented for any vehicle moving relative to a reference plane such as the ground. The vehicle can move for example by means of wheels or articulated legs. The vehicle comprises a bottom planar surface parallel to the reference plane and the tool makes it possible to raise this surface by bearing on the reference plane.

The invention is of particular use for raising a robot 10 of humanoid nature as represented in FIG. 1. The tool according to the invention can of course be used for other types of vehicles.

The robot 10 comprises a head 1, a torso 2, two arms 3, two hands 4 and a skirt 7 making it possible to lower the center of gravity of the robot and thus obtain a good stability.

The robot 10 comprises a number of articulations allowing the relative movement of the different limbs of the robot 10 in order to reproduce the human morphology and the movements thereof. The robot 10 comprises, for example, an articulation 11 between the torso 2 and each of the arms 3. The articulation 11 is motorized about two rotation axes to make it possible to move the arm 3 relative to the torso 2 in the manner of the possible movements by a shoulder of a human being.

The skirt 7 comprises a first articulation 12 belonging to a knee, between a leg 7a and a thigh 7b. A second articulation 13 belonging to a hip is mounted between the torso 2 and the thigh 7b. These two articulations 12 and 13 are pivot links motorized about a rotation axis. The rotation axis Xa of the articulation 12 and the rotation axis Xb of the articulation 13 are substantially parallel to an axis linking the two shoulders of the robot, making it possible to tilt the robot forward or backward.

The skirt 7 comprises, at its base, a tripod 14 making it possible to move the robot 10. The tripod 14 comprises three wheels 15, 16 and 17 articulated relative to the tripod. An example of a wheel that can be implemented is described in the patent application published under the number FR 2 989 935 and filed in the name of the applicant. The wheels 15, 16 and 17 are motorized and ensure the movement of the robot 10 in all the directions of the reference plane.

FIGS. 2a and 2b represent, in cross section in a vertical plane, the tripod 14 and a tool 20 making it possible to raise it relative to the horizontal reference plane 21. The tripod 14 has a bottom horizontal surface 22 parallel to the reference plane 21. The tool 20 is intended to bear on the reference plane 21 to raise the surface 22 and consequently the robot 10 as a whole. The tool 20 makes it possible to raise one of the wheels relative to the reference plane 21. The tool 20 is slid under the tripod 14 by an operator between the reference plane 21 and the surface 22 in the vicinity of one of the wheels, for example the wheel 15 as represented in FIGS. 2a and 2b. The tool 20 is formed by a single-piece part having a branch 23 extending essentially along a main axis 24 at right angles to the plane of FIGS. 2a and 2b. The tool 20 is intended to be operated by the operator substantially in a rotational movement about the main axis 24 of the branch 23.

In FIG. 2a, the wheels 15, 16 and 17 are all in contact with the reference plane 21 and, in FIG. 2b, the wheel 15 is raised. Between the two figures, the branch 23 has been turned about its main axis 24 by approximately 90°.

FIG. 3 represents a cross section the branch 23 in a plane at right angles to its main axis 24. In order to raise the tripod 14, the branch 23 has a particular form. More specifically, in a section of the branch 23 at right angles to the main axis 24, two overall distances D1 and D2 are defined that are angularly offset from one another. The first distance D1 is less than the second distance D2. The distances D1 and D2 are defined as a function of a distance D separating the reference plane 21 from the surface 22 when the three wheels are resting on the reference plane 21. This distance D represents the ground clearance of the robot 10. The distance D is at right angles to the reference plane 21. The distance D1 is less than the distance D and the distance D2 is greater than the distance D. Thus, the operator can introduce the branch 23 under the surface 22 by keeping the distance D1 substantially at right angles to the reference plane 21. The difference between the two distances D1 and D allows for a free sliding of the branch 23 under the robot 10. By applying a rotation of the branch 23 about its main axis 24, the operator brings the distance D2 at right angles to the reference plane 21. Since the distance D2 is greater than the ground clearance, the robot 10 is raised at the point of contact between the branch 23 and the surface 22. The section of the branch 23 in which the distances D1 and D2 lie extends along the main axis 24 over a sufficient length to raise the robot 10.

The angular offset between the two overall distances D1 and D2 can be any, while remaining less than 180°. In the example represented, the distances D1 and D2 are substantially at right angles to one another.

Advantageously, in order to improve the stability of the robot 10 when it is raised, when the operator raises the robot 10, during the rotation of the branch 23, it is possible to have the robot 10 pass through a high point then relower it slightly beyond this high point in order to avoid having the robot 10 fall over on its wheels by itself. To this end, in the section of the branch where the distances D1 and D2 are defined, a third overall distance Dmax is defined that is angularly offset from the distance D1 less than the distance D2. The distance Dmax is greater than the distance D2.

The offset angles between the distances can be seen in FIG. 3. An angle αm separates the axes of the distances D1 and Dmax and an angle α2 separates the axes of the distances D1 and D2.

The stability of the robot 10 can still be improved in the raised position. To this end, the section of the branch 23 has two planar surfaces 27 and 28 separated by the second distance D2. The planar surface 28 is intended to come into contact with the reference plane 21 and the planar surface 27 is intended to come into contact with the surface 22 of the robot 10.

FIG. 4 represents a curve showing the appearance of the trend of a current distance d as a function of the rotation angle a of the branch 23. For a zero angle, the distance D1 is less than the distance D. The distance d increases between a zero angle α and the angle αm. The distance d decreases between the angles αm and α2. Finally, the distance d increases beyond the angle α2. This new increase is due to the presence of the two planar surfaces 27 and 28. The stability of the robot in the raised position is obtained when the distance d reaches a minimum, in this case the distance D2, obtained for the angle α2.

The branch 23 can be terminated at one of its ends by a form allowing the rotational drive thereof about its main axis 24. It can be a square or hexagonal section on which the operator can position a driving key. Alternatively, the tool 20 comprises a handle 30 making it possible, in an operational position, to rotate the branch 23 about its main axis 24. Advantageously, the handle 30 extends substantially at right angles to the branch 23. The handle 30 allows the operator to rotate the branch 23 about its main axis 24.

The tool 20 comprising the branch 23 and the handle 30 can be seen in FIGS. 5a and 5b. In FIG. 5a, the branch 23 can slide freely under the surface 22 of the robot 10. The distance D1 is at right angles to the reference plane 21. The tool 20 is in the position of FIG. 2a. In FIG. 5b, the tool 20 is in the position of FIG. 2b. The distance D2 is at right angles to the reference plane 21. Between the positions of the tool 20 of FIGS. 5a and 5b, the operator has turned the branch by the angle α2 by operating the handle 30.

Advantageously, in the position of FIG. 5b, the handle 30 rests on the reference plane 21. It is possible to do without the planar surfaces 27 and 28. The curve represented in FIG. 4 can decrease beyond the angle αm and this decrease can be continued beyond the angle α2. The position of stability of the tool 20 is then assured when the handle 30 rests on the reference plane 21. The decrease of the current distance d is interrupted when the handle 30 comes into contact with the reference plane 21.

In its use, the tool 20 enters into contact both with the reference plane 21 and with the planar surface 22. With the branch 23 rotating about its main axis 24, tangential loads occur at the level of the contacts. These loads can be reflected either by a movement of the robot 10 parallel to the reference plane 21 or by a slipping at the level of one of the contacts. The movement of the robot 10 relative to the reference plane 21 is not desirable. It is possible to form the tool 20 in order to limit the risk of movement and advantageously to choose the contact likely to slip.

To this end, relative to a plane 32 containing the main axis 24, outer surfaces 33 and 34 of the branch 23 situated on either side of the plane 32 have different friction coefficients. The lower friction coefficient is chosen for the surface at which a slip is desired.

The reference plane 21 can be of different kinds. It is the ground and the operator can decide to raise the robot 10 on different types of ground. By contrast, the surface 22 for the robot 10 and the surface 34 for the branch 23 are better controlled. A choice can be made for the surface having the higher friction coefficient to be intended to come into contact with the robot 10, in this case the surface 34, and the surface having the lower friction coefficient to be intended to come into contact with the reference plane, in this case the surface 33. It is for example possible to cover the surface 34 with a rubber pad or with a silicone-based material. The surface 33 can be covered with a pad in a material having a good slip like for example polytetrafluoroethylene (PTFE).

Advantageously, the handle 30 can be dismantled from the branch 23 in order to allow easier storage of the tool 20. FIGS. 6 and 7 represent the tool 20 alone. FIG. 6 represents the handle 30 assembled with the branch 23 in a relative operational position, also called mounted position, making it possible to raise the robot 10, and FIG. 7 represents the handle 30 in a folded-down position, also called dismantled position, relative to the branch 23. In the position of FIG. 7, the handle 30 extends parallel to the main axis 24 of the branch 23. The tool 20 advantageously comprises means for maintaining the handle relative to the tool in the folded-down position. In order to limit the bulk, these maintaining means can be formed by one or more permanent magnets 40 and 42 arranged in the handle 30. The branch 23 then comprises an inclusion of one or more magnetic elements 41 and 43, each formed either by a ferromagnetic material or by a permanent magnet arranged so as to produce a mutual attraction of the handle 30 and of the branch 23 in the folded-down position. More generally, the handle 30 and the branch 23 comprise magnetic elements 40 to 43 cooperating with one another to maintain the handle 30 and the branch 23 in the folded-down position.

In the robot 10, a sheath can be provided that makes it possible to slide the folded-down assembly.

An example of forms making it possible to drive the branch 23 by the handle 20 can be seen in FIG. 7. The branch 23 can comprise a male square 36 and the handle 30 can comprise a female square 37 intended to cooperate with the square 36 for the rotational driving of the branch 23. The square 36 extends along the main axis 24 and the insertion of the male square 36 into the female square 37 is done in translation along the main axis 24. The two squares can each comprise a corresponding cut face allowing for a polarization in the relative functional position of the handle 30 relative to the branch 23. The maintaining in position of the handle 30 in the functional position relative to the branch 23 can be done by means of magnetic elements (ferromagnetic element or permanent magnet) arranged in the squares 36 and 37. Advantageously, one of the magnetic elements makes it possible to both maintain the handle 30 and the branch 23 in a folded-down position and in a functional position. For example, the magnetic element 40 arranged in the handle 30 can cooperate with a magnetic element 44 arranged in the square 36 in the functional position. The magnetic element 40 then fulfils a dual function, by cooperating either with the magnetic element 41 in the folded-down position or with the magnetic element 44 in the functional position.

1. A tool intended for raising a vehicle relative to a reference plane on which the vehicle is intended to move, the tool being formed by a single-piece part having a branch extending essentially along a main axis, intended to be placed between the vehicle and the reference plane and to be operated by an operator substantially in a rotational movement about the main axis of the branch, in a section of the branch at right angles to the main axis and extending along the main axis, two overall distances D1 and D2 are defined that are angularly offset from one another, the first distance D1 being less than the second distance D2, the distance D1 being intended to be less than a distance D separating the vehicle from the reference plane and the distance D2 being intended to be greater than the distance D, the tool comprising a handle that can be dismantled from the branch and that makes it possible, in a mounted position, to rotate the branch about its main axis, wherein the handle and the branch comprise magnetic elements cooperating with one another to maintain the handle and the branch in a dismantled position.

2. The tool as claimed in claim 1, wherein the two overall distances D1 and D2 are substantially at right angles to one another.

3. The tool as claimed in claim 1, wherein, in the section of the branch, a third overall distance Dmax is defined that is angularly offset from the distance D1 less than the distance D2 and wherein the distance Dmax is greater than the distance D2.

4. The tool as claimed in claim 1, wherein the section of the branch has two planar surfaces separated by the second distance D2.

5. The tool as claimed in claim 1, wherein, relative to a plane containing the main axis, outer surfaces of the branch situated on either side of the plane have different friction coefficients.

6. The tool as claimed in claim 5, wherein the surface having the higher friction coefficient is intended to come in contact with the vehicle and the surface having the lower friction coefficient is intended to come into contact with the reference plane.

7. The tool as claimed in claim 1, wherein the handle, in the mounted position, extends substantially at right angles to the branch.

8. The tool as claimed in claim 1, wherein one of the magnetic elements makes it possible to both maintain the handle and the branch in the dismantled position and in the mounted position.
